(19) United States
(12) Patent Application Publication
(10) Pub. No.: US 2023/0199770 A1
(43) Pub. Date: Jun. 22, 2023

(54) METHOD AND APPARATUS FOR SIDELINK COMMUNICATION OVER UNLICENSED BAND USING INTERLACED WAVEFORM

(71) Applicant: Samsung Electronics Co., Ltd., Gyeonggi-do (KR)

(72) Inventors: Liang HU, San Diego, CA (US); Philippe Jean Marc Michel SARTORI, Naperville, IL (US); Yaser Mohamed Mostafa Kamal FOUAD, San Diego, CA (US)

(21) Appl. No.: 17/990,374

(22) Filed: Nov. 18, 2022

Related U.S. Application Data
(60) Provisional application No. 63/292,143, filed on Dec. 21, 2021.

(51) Int. Cl. H04W 72/12

(52) U.S. Cl. CPC H04W 72/1278

(57) ABSTRACT

An apparatus and a method are disclosed for SL communication over an unlicensed band by utilizing a frequency interlaced design. A method performed by a UT includes determining whether the UE is operating in a localized mode or an interlaced mode for SL communication, and in response to determining that the LE is operating in the interlaced mode, decoding first stage SCI of a PSCCH based on an interlaced mapping scheme, decoding second stage SCI of a PSSCH based on the decoded first stage SCI, and decoding the PSSCH based on the decoded first and second stage SCI.

### CROSS-REFERENCE TO RELATED APPLICATION

This application claims the priority benefit under 35 U.S.C. § 119(e) of U.S. Provisional Application No. 63/292,143, filed on Dec. 21, 2021, the disclosure of which is incorporated by reference in its entirety as if fully set forth herein.

### TECHNICAL FIELD

The disclosure generally relates to sidelink (SL) communication over an unlicensed band. More particularly, the subject matter disclosed herein relates to improvements in SL communication over an unlicensed band by utilizing a frequency interlaced design.

### SUMMARY

Starting in Release-16, the 3^{rd} generation partnership project (3GPP) has been standardizing SL communications, which allow user equipments (UEs) to communicate directly with each other, with limited or no transmission through an infrastructure node (e.g., a gNB).

Up to Release-17, the 3GPP SL specifications have focused on public safety and vehicle-to-vehicle (V2V) over intelligent transport system (ITS) bands. However, as interactive services such as interactive gaming, data sharing between various kinds of terminals such as mobile phones, virtual reality (VR)/augmented reality (AR) devices and robots are being developed, many of these interactive services are local in nature, and benefit from the integration of cellular communications with SL communications.

FIG. 1 illustrates an example of control and data paths a network controlled interactive service (NCIS). More specifically, configuration A in FIG. 1 illustrates a control path and a data path using the same frequency and configuration B in FIG. 1 illustrates a control path and a data path using different frequencies.

Referring to FIG. 1, data paths and control paths may be deployed on a cellular link (a Uu link) or on an SL (a PC5 link). Most of the control plane is transmitted through the network, while most of the data and some control information are transmitted on the SL.

Unlicensed band in 5/6 GHz band and 60 GHz band may provide large additional bandwidth and flexibility to SL data transmission. As such, it is expected that in Release-18, 3GPP will standardize SL communication in the unlicensed band. However, to provide proximity services (ProSe) services in an unlicensed band, various regulation requirements need to be met.

For transmission in unlicensed bands, regulations require that a UE occupy a substantial fraction of the channel in frequency domain in order to meet power spectral density (PSD) and occupied channel bandwidth (OCB) constraints.

More specifically, operation in unlicensed spectrum is subject to power limits in all regions and bands, in terms of equivalent isotropically radiated power (EIRP) and PSD, to constrain the generated inter-radio access technology (RAT) and intra-RAT interference levels. For example, according to European Telecommunications Standards Institute (ETSI) regulations, in a 5 GHz band, the maximum mean EIRP and PSD with transmit power control for 5.15-5.35 GHz range are limited to 23 dBm and 10 dBm./MHz, respectively, and for 5.47-5.725 GHz range, are limited to 30 dBm and 17 dBm/MHz, respectively.

Further, the OCB is defined as the bandwidth containing 99% of the signal power and, in certain regions, it should be larger than a percentage of a nominal channel bandwidth (NCB) (i.e., a listen-before-talk (LBT) channel width). This enforces the unlicensed technologies to use major part of the channel bandwidth when they access the channel. According to ETSI, for the 5 GHz band, the OCB shall be between 70% and 100% of the NCB.

Due to the regulation constraints on EIRP, PSD, and OCB described above, new radio unlicensed (NR-U) supports a frequency interlacing structure in physical uplink control channel (PUCCH)/physical uplink shared channel (PUSCH) such that associated resource blocks (RBs) are spread within a sub-band that is available for transmission.

Interlaced Uplink Design for Unlicensed Access in NR

In Release-15, a PUSCH resource in frequency domain may have two types of resource mapping, type 0 and type 1. For type 0, the resource allocation information is included in downlink control information (DCI) 0_0 or DCI 0_1, which indicates a bitmap of RB groups (RBGs). An RBG is a set of consecutive virtual RBs defined by rbg-Size in pusch-Config and the size of a bandwidth part (BWP). For type 1, a resource indication value (RIV) corresponding to a starting virtual RB RBₛₜₐᵣₜ and a length L_{RBs} in terms of contiguously allocated RBs is signaled to a -UE in DCI 0_0 or DCI 0_1.

In NR-U, a PUSCH resource in the frequency domain supports an interlacing structure and the associated resource allocation information may be signaled with a set of interlace indexes. If subcarrier spacing (SCS)=15 kHz, a set of interlace indexes represented by a 6 bit RIV value are signaled and, if SCS=30 kHz, a set of interlace indexes indicated by a 5 bit bitmap are signaled. The interlace index information can be signaled in DCI 0_1 scheduling a PUSCH, DCI activating a Type-2 configured grant, a radio resource control (RRC) configuration for a Type-1 configured grant, and DCI 0_0 scrambled by a temporary cell-radio network temporary identifier (TC-RNTI). The different signals in SCS=15 kHz and SCS=30 kHz are used to address resource allocation signaling overhead when different numbers of total interlaces are considered, i.e., 5 interlaces for SCS=30 kHz and 10 interlaces for SCS=15 kHz. In particular, for SCS=15 kHz, continuous interlace indexes signaled by an RIV are allowed for MISCH resource allocation. To improve resource allocation flexibility, for RIV≥55, sonic non-contiguous interlace indexes m₀+l be assigned based on the RIV value and the associated interpretation in Table 1 below.

TABLE 1

| RIV − 55 | m₀ | l |
|---|---|---|
| 0 | 0 | {0, 5} |
| 1 | 0 | {0, 1, 5, 6} |
| 2 | 1 | {0, 5} |
| 3 | 1 | {0, 1, 2, 3, 5, 6, 7, 8} |
| 4 | 2 | {0, 5} |
| 5 | 2 | {0, 1, 2, 5, 6, 7} |
| 6 | 3 | {0, 5} |
| 7 | 4 | {0, 5} |

Consequently, a 6 bit RIV, instead of a 10 bit bitmap, is included in DCI when SCS=15 kHz, For SCS=30 kHz, there is no restriction on assigning interlace indexes and a bitmap of 5 bits is used,

Interlace Structure

In addition to the frequency domain resource mapping in Release-15 for a PUSCH and a PUCCH, NR-U supports a frequency domain interlace structure for mapping in order to spread RBs within an assigned 13NNTP, where a PUCCH resource is confined within an RB set (e.g., a 20 MHz LBT sub-ba.nd.) and a PUSCH resource can be allocated across multiple RB sets. The configuration of the interlace structure is consistent among PUCCH and PUSCH configurations, i.e., if a PUCCH frequency domain is configured with the interlace structure, then a PUSCH is also configured with the interlace structure.

For SCS=15 kHz and SCS=30 kHz, the total number of available interlaces M is 10 and 5, respectively.

FIG. 2 illustrates an example of an interlace 0 resource, when SCS=15 kHz.

Referring to FIG. 2, each interlace is associated with an interlace index m and includes common RBs (CRI3s) with indexes {RB_{start,m}, RB_{start,m}+M, RB_{start,m}+2M, . . . }, where RB_{start,m}=m and CRB0 is the reference point. When a PUCCH or PUSCH is configured with interlace indexes in an active BWP, only the RI3s within the BWP are allocated.

SL Frame Structure

In NR SL, a self-contained approach is considered, whereby each slot contains control information, data, and in some cases, feedback.

The control information is carried in SL control information (SCI), which is transmitted in two stages. The first-stage SCI is carried on a physical SL control channel (PSCCH) and contains information for sensing operations, as well as information about a resource allocation of a second-stage SCI. The second-stage SCI is transmitted in a physical SL shared channel (PSSCH) resources and is associated with a PSSCH demodulation reference signal (DMRS).

FIG. 3 illustrates an example of multiplexing between a PSCCH and a PSSCH is in time and frequency within a slot.

Referring to FIG. 3, the first symbol in the slot is a copy of the second symbol, which is designed for automatic gain control (AGC) training. The 1st stage SCI is carried in the PSCCH with 2 or 3 orthogonal frequency-division multiplexing (OFI)M) symbols with SCI format 1-A. The number of PSCCH symbols is explicitly (pre-)configured for each transmission/reception (Tx/Rx) resource pool using timeResourcePSCCH. The lowest RB of a PSCCH is the same as a lowest RB of a corresponding PSSCH. In the frequency domain, the number of RBs in the PSCCH is pre-configured, and is not greater than the size of one sub-channel. in this case, if a UE is using multiple consecutive subchannels for an SL transmission within a slot, the PSCCH will only exist in the first subchannel.

An SL-shared channel (SCI) transport channel, which carries transport blocks (TBs) of data for transmission over an SL, and the 2nd stage SCI is carried over the PSSCH. The 2nd stage SCI starts only after the first DMRS symbol in the PSSCH so that the 2nd stage SCI can have a good channel estimate due to its proximity to the :DIVERS symbol. Hence, the 2nd stage SCI can occur after some data is transmitted because. The resources in which the PSCCH/PSSCH are transmitted can be scheduled or configured by a gNB (i.e., Mode 1) or determined through a sensing procedure conducted autonomously by a transmitting UE (i.e., Mode 2).

The feedback (if it exists) is carried over a physical St, feedback channel (PSFCH). The PSFCH may be used to transmit the feedback information from Rx UEs to Tx LiEs and can be used for uni cast and groupcast options 2/1. In case of unicast and groupcast option 2, the PSFCH is used to transmit acknowledgement/negative: acknowledgement (ACK/NACK), whereas for the case of groupcast option 1, the PSFCH carries only NACK. For SL feedback, a sequence-based PSFCH format (PSFCH format 0) with one symbol (not including an AGC training period) is supported.

In PSFCH format 0, an ACK/NACK bit is transmitted through two Zadoff-Cu (ZC) sequences of length 12 (with the same root, but different cyclic shifts), whereby the presence of one sequence indicates an ACK and the presence of the other sequence indicates a NACK (i.e., the sequences are used in a mutually exclusive manner).

Mapping to PSFCH Resources

In NR SL, three types of PSFCH-based transmissions are considered based on the cast type as follows:

Unicast transmission in which an Rx UE provides an ACK/NACK to a Tx UE upon request (i.e., when hybrid automatic repeat request (HARQ) is enabled by the Tx UE in corresponding SCI;

Groupcast transmission option 2 in which each of the intended Rx UEs within a group provides an ACK/NACK to a Tx UE upon request (i.e., when HARQ is enabled by the Tx UE in the corresponding SCI); and

Groupcast option I in which each one of the intended Rx UEs within a group provides a ISACK only when it fails to receive and when it falls within an area covered by a Tx UE as indicated by the SCI. Here, all of the UEs use the same PSFCH sequence to provide the NACK. For each PSCCH/PSSCH transmission, a set of corresponding PSFCH resources are identified based on a mapping rule. The set contains multiple RBs and is in a specified time slot that corresponds to the PSCCH/PSSCH transmission. Within each RB, there are 12 subcarriers, which allows for transmission of up to 12 orthogonal ZC sequences. To provide the feedback, each UE uses two sequences (i.e., one for transmitting an ACK and another to transmit a NACK) based on a Tx LIE physical identifier (ID).

A UE can be indicated by an SCI format scheduling a PSSCH reception, in one or more sub-channels from a number of N_{subch}^{PSSCH} sub-channels, to transmit a PSFCH with HARQ-ACK information in response to the PSSCH reception. The UE may provide HARQ-ACK information that includes an ACK or a NACK, or only a NACK.

A UE can be provided, by sl-PSFOI-Period-r16, a number of slots in a resource pool for a period of PSFCH transmission occasion resources. If the number is zero, PSFCH transmissions from the UE in the resource pool are disabled.

A UE expects that a slot t′ₖ^{SL} (0≤k≤T′ₘₐₓ) has a PSFCH transmission occasion resource if k mod N_{PSSCH}^{PSFCH}=0, where T′ₘₐₓ is a number of slots that belong to the resource pool within 10240 msec, and N_{PSSCH}^{PSFCH} is provided by sl-PSFCH-Period-r16.

A UE may be indicated by higher layers to not transmit a PSFCH in response to a PSSCH reception.

If a UE receives a PSSCH in a resource pool and the HARQ feedback enabled/disabled indicator field in an associated SCI format 2-A or 2-B has value 1, the UE provides the HARQ-ACK information in a PSFCH transmission in the resource pool. The UE transmits the PSFCH in a first slot that includes PSFCH resources and is at least a number of slots (provided by sl-MinTimeGaPSFCH-r16) of the resource pool after a last slot of the PSSCH reception.

The sl-PSFCH-RB-Set-r16 provides a UE with a set of M_{PRB,set}^{PSFCH} physical RBs (PRBs) in a resource pool for a PSFCH transmission in a PRB of the resource pool. For a number of N_{subch} sub-channels for the resource pool, provided by sl-NumSubchannel, and a number of PSSCH slots associated with a PSFCH slot, which is less than or equal to N_{PSSCH}^{PSFCH}, the UE allocates the [(i+j·N_{PSSCH}^{PSFCH})·M_{subch, slot}^{PSFCH}, (i+1+j·N_{PSSCH}^{PSFCH})·M_{subch, slot}^{PSFCH}−1] PRBs from the M_{PRB, set}^{PSFCH} PRBs to slot i among the PSSCH slots associated with the PSFCH slot and sub-channel j, where M_{subch, slot}^{PSFCH}=M_{PRB, set}^{PSFCH}/(N_{subch}·N_{PSSCH}^{PSFCH}), 0≤i<N_{PSSCH}^{PSFCH}, and the allocation starts in an ascending order of i and continues in an ascending order of j. The LTE expects that M_{PRB, set}^{PSFCH} is a multiple of N_{subch}·N_{PSSCH}^{PSFCH}.

A UE determines a number of PSFCH resources available for multiplexing HARQ-ACK information in a PSFCH transmission as R_{PRB, CS}^{PSFCH}=N_{type}^{PSFCH}·M_{subch, slot}^{PSFCH}·N_{CS}^{PSFCH}, where N_{CS}^{PSFCH} is a number of cyclic shift pairs for the resource pool and, based on an indication by higher layers:

N_{type}^{PSFCH}=1 and the M_hd subch, slot^{PSFCH} PRBs are associated with the starting sub-channel of the corresponding PSSCH; and

N_{type}^{PSFCH}=N_{subch}^{PSSCH} and the N_{subch}^{PSSCH}·M_{subch, slot}^{PSFCH} PRBs are associated with one or more sub-channels from the N_{subch}^{PSSCh} sub-channels of the corresponding PSSCH.

The PSFCH resources are first indexed according to an ascending order of the PRB index, from the N_{type}^{PSFCH}·M_{subch, slot}^{PSFCH} PRBs, and then according to an ascending order of the cyclic shift pair index from the N_{CS}^{PSFCH} cyclic shift pairs.

A UE determines an index of a PSFCH resource for a PSFCH transmission in response to a PSSCH reception as (P_{ID}+M_{ID})modR_{PRB, CS}^{PSFCH}, where P_{ID} is a physical layer source ID provided by SCI format 2-A or 2-B scheduling the PSSCH reception, and M_{ID} is the identity of the UE receiving the PSSCH, as indicated by higher layers, if the UE detects SCI format 2-A with a cast type indicator field value of “01”; otherwise, M_{ID} is zero.

A UE determines an m₀ value, for computing a value of cyclic shift α, from a cyclic shift pair index corresponding to a PSFCH resource index and from N_{CS}^{PSFCH} using Table 2 below.

TABLE 2

| | m₀ | | | | | |
|---|---|---|---|---|---|---|
| | Cyclic | Cyclic | Cyclic | Cyclic | Cyclic | Cyclic |
| | Shift | Shift | Shift | Shift | Shift | Shift |
| | Pair | Pair | Pair | Pair | Pair | Pair |
| N_{CS}^{PSFCH} | Index 0 | Index 1 | Index 2 | Index 3 | Index 4 | Index 5 |
| 1 | 0 | — | — | — | — | — |
| 2 | 0 | 3 | — | — | — | — |
| 3 | 0 | 2 | 4 | — | — | — |
| 6 | 0 | 1 | 2 | 3 | 4 | 5 |

A UE determines an m_{cs} value for computing a value of cyclic shift α, as in Table 2, if the UE detects SCI format 2-A with a cast type indicator field value of “01”or “10”, or as in Tables 3 or 4 below, if the UE detects SCI format 2-B or 2-A with a cast type indicator field value of “11”. The UE applies one cyclic shift from a cyclic shift pair to a sequence used for the PSFCH transmission.

TABLE 3

| HARQ-ACK Value | 0 (NACK) | 1 (ACK) |
|---|---|---|
| Sequence cyclic shift | 0 | 6 |

TABLE 4

| HARQ-ACK Value | 0 (NACK) | 1 (ACK) |
|---|---|---|
| Sequence cyclic shift | 0 | N/A |

As shown above, Tables 3 and 4 may be used for mapping HARQ-ACK information bit values to a cyclic shift, from a cyclic shift pair, of a sequence for a PSFCH transmission, when HARQ-ACK information includes an ACK or a NACK or when the HARQ-ACK information includes only a NACK, respectively.

NR Sidelink Mode-2 Resource Allocation Procedure

Release-16 SL Mode-2 Resource Allocation Procedure [TS 38.214] provides:

8.1.4 UE procedure for determining the subset of resources to be reported to higher layers in PSSCH resource selection in sidelink resource allocation mode 2

In resource allocation mode 2, the higher layer can request the UE to determine a subset of resources from which the higher layer will select resources for PSSCH/PSCCH transmission. To trigger this procedure, in slot n, the higher layer provides the following parameters for this PSSCH/PSCCH transmission:
the resource pool from which the resources are to be reported;
L1 priority, prio_{TX},
the remaining packet delay budget;
the number of sub-channels to be used for the PSSCH/PSCCH transmission in a slot, L_{subCH};
optionally, the resource reservation interval, P_{rsvp_Tx}, in units of ms,
if the higher layer requests the UE to determine a subset of resources from which the higher layer will select resources for PSSCH1PSCCH transmission as part of re-evaluation or pre-emption procedure, the higher layer provides a set of resources (r₀, r₁, r₂, . . . ) which may be subject to re-evaluation and a set of resources (r+₀, r′₁, r′₂, . . . ) which may be subject to pre-emption.
it is up to UE implementation to determine the subset of resources as requested by higher layers before or after the slot rᵢ″−T₃, where rᵢ″ is the slot with the smallest slot index among (r₀, r₁, r₂, . . . ) and (r₀′, r₁′, r₂′, . . . ) and T₃ is equal to T_{proc,1}^{SL}, where T_{proc,1}^{SL} is defined in slots in Table 8.1.4-2 where μ_{SL} is the SCS configuration of the SL BWP.

The following higher layer parameters affect this procedure:
sl-SelectionWindowList: internal parameter T₂ₘᵢₙ is set to the corresponding value from higher layer parameter sl-SeiecilonWintiowList for the given value of prio_{TX}.
sl-IhresPSSCH-RSRP-List this higher layer parameter provides an RSRP threshold for each combination (oᵢ, pⱼ), where pᵢ is the value of the priority field in a received SCI format 1-A and pⱼ is the priority of the transmission of the UE selecting resources; for a given invocation of this procedure, pⱼ=prio_{TX}.
sl-RS-ForSensing selects if the uses the PSSCH-RSRP or PSCCH-RSRP measurement, as defined in clause 8.4.2.1.
sl-ResourceReservePeriodList-r16
sl-SensingWindow: internal parameter T₀ is defined as the number of slots corresponding to sl-SensingWindow ms.
sl-Tx-PercentageList: internal parameter X for a given prio_{TX} is defined as sl-TxPereentageList (prio_{TX}) converted from percentage to ratio
sl-PreemptionEnable: if sl-PreemptionEnable-r16 is provided, and if it is not equal to ‘enabled’, internal parameter prioₚᵣₑ is set to the higher layer provided parameter sl-PreemptionEnable

The resource reservation interval, P_{rsvp_TX}, if provided, is converted from units of ms to units of logical slots, resulting in P′_{rsvp_TX} according to clause 8.1.7.

### Notation:

(t₀^{SL}, t₁^{SL}, t₂^{SL}, . . . ) denotes the set of slots which can belong to a sidelink resource pool and is defined in Clause 8.

The following steps are used:
1) A candidate single-slot resource for transmission R_{x,y} is defined as a set of L_{subCH} contiguous sub-channels with sub-channel x+j in slot t_{y}^{SL} where j=0, . . . , L_{subCH}−1. The UE shall assume that any set of L_{subCH} contiguous sub-channels included in the corresponding resource pool within the time interval [n+T₁, n+T₂] correspond to one candidate single-slot resource, where
   selection of T₁ is up to UE implementation under 0≤T₁≤T_{proc,1}^{SL}, where T_{proc,1}^{SL} is defined in slots in Table 8.1.4-2 where μ_{SL} is the SCS configuration of the SL BWP;
   if T₂ₘᵢₙ is shorter than the remaining packet delay budget (in slots) then T₂ is up to UE implementation subject to T₂ₘᵢₙ≤T₂≤ remaining packet budget (inslots); otherwise T2 is set to the remaining packet delay budget (in slots).

The total number of candidate single-slot resources is denoted by Mₜₒₜₐₗ.
2) The sensing window is defined by the range of slots [n−T₀, n−T_{proc,0}^{SL}] where T₀ is defined above and T_{proc,0}^{SL} is defined in slots in Table 8.1.4-1 where μ_{SL} is the SCS configuration of the SL BWP. The UE shall monitor slots which can belong to a sidelink resource pool within the sensing window except for those in which its own transmissions occur. The UE shall perform the behaviour in the following steps based on PSCCH decoded and RSRP measured in these slots.
3) The internal parameter Th(pᵢ, pⱼ) is set to the corresponding value of RSRP threshold indicated by the i-th field in sl-ThresPSSCH-RSRP-List-r16, where i=pᵢ+(pⱼ−1)*8.
4) The set S_{A} is initialized to the set of all the candidate single-slot resources.
5) The UE shall exclude any candidate single-slot resource R_{x,y} from the set S_{A} if it meets all the following conditions:
   the UE has not monitored slot tₘ^{SL} in Step 2.
   for any periodicity value allowed by the higher layer parameter sl-ResourceReservePeriodList-r16 and a hypothetical SCI format 1-A received in slot tₘ^{SL} with “Resource reservation period”field set to that periodicity value and indicating all subchannels of the resource pool in this slot, condition c in step 6 would be met.
6) The UE shall exclude any candidate single-slot resource R_{x,y} from the set S_{A} if it meets all the following conditions:
   a) the LIE receives an SCI format 1-A in slot tₘ^{SL}, and “Resource reservation period” field, if present, and “Priority” field in the received SCI format 1-A indicate the values P_{rsvp_RX} and prio_{RX}, respectively according to Clause 16.4 in [6, TS 38.213];
   b) the RSRP measurement performed, according to clause 8.4.2.1 for the received SCI format 1-A, is higher than Th(prio_{RX}, prio_{TX});
   c) the SCI format received in slot tₘ^{SL} or the same SCI format which, if and only if the “Resource reservation period” field is present in the received SCI format 1-A, is assumed to be received in slot(s) t-hd m+q×P′_{rsvp_RX}^{SL} determines according to clause 8.1.5 the set of resource blocks and slots which overlaps with R_{x,y+j×P′}_{_{rsvp_TX}} for q=1, 2, . . . , Q and J=0, 1, . . . , Cᵣₑₛₑₜ−1. Here, P′_{rsvp_RX} is P_{rsvp_RX} converted to units of logical slots according to clause 8.1.7, Q =

$$⌈ \frac{{T}_{scal}}{{P}_{rsvp , RX}} ⌉$$

if P_{rsvp_RX}<T_{scal} and n′−m≤P′_{rsvp_RX}, where t_{n′}^{SL}=n if slot n belongs to the set (t₀^{SL}, t₁^{SL}, . . . , t_{T}_{ₘₐₓ}^{SL}); otherwise slot t_{n′}^{SL} is the first slot after slot n belonging to the set (t₀^{SL}, t₁^{SL}, . . . , t_{T}_{ₘₐₓ}^{SL}); otherwise Q=1. T_{scal} is set to selection window size T₂ converted to units of ms.
7) If the number of candidate single-slot resources remaining in the set S_{A} is smaller than X·Mₜₒₜₐₗ, then Th(pᵢ,pⱼ) is increased by 3 dB for each priority value Th(pᵢ, pⱼ) and the procedure continues with step 4.

The UE shall report set S_{A} to higher layers.

If a resource rᵢ from the set (r₀, r₁, r₂, . . . ) is not a member of S_{A}, then the LE shall report re-evaluation of the resource rᵢ to higher layers.

If a resource rᵢ′ from the set (r₀′, r₁′, r₂′, . . . ) is not a member of S_{A} due to exclusion in step 6 above by comparison with the RSRP measurement for the received SCI format 1-A with an associated priority prio_{RX}, and satisfy one of the following conditions, then the UE shall report pre-emption of the resource rᵢ′ to higher layers.
sl-PreemptionEnable is provided and is equal to ‘enabled’ and prio_{TX}>prio_{RX}
sl-PreemptionEnable is provided and is not equal to ‘enabled’, and prio_{RX}<prioₚᵣₑ and prio_{TX}>prio_{RX}

TABLE 8.1.4-1
T_{proc, 0}^{SL} depending on sub-carrier spacing

| μ_{SL} | T_{proc, 0}^{SL} [slots] |
|---|---|
| 0 | 1 |
| 1 | 1 |
| 2 | 2 |
| 3 | 4 |

TABLE 8.1.4-2
T_{proc, 1}^{SL} depending on sub-carrier spacing

| μ_{SL} | T_{proc, 1}^{SL} [slots] |
|---|---|
| 0 | 3 |
| 1 | 5 |
| 2 | 9 |
| 3 | 17 |

As described above, for transmission in unlicensed bands, regulations require that a UE occupies a substantial fraction of the channel in the frequency domain so that PSD and OCB constraints are met. However, the current design of SL transmissions relies on the use of localized transmissions in frequency. Therefore, there is a need for a new mapping of physical channels to actual RBs for SL unlicensed communications.

To solve this problem, in accordance with an embodiment of the disclosure, an interlaced design is provided, which allows for the use of existing SL procedures with as little modification as possible. That is, a method and an apparatus are provided for performing SL communications over an unlicensed band using a frequency interlaced design to meet OCB requirements and allow for a higher total transmit power without exceeding a certain PSD limit. While the mapping to physical RBs (PRBs) is different, existing procedures can still be reused. In particular, no change is applied to the SCI format, and the Release-16/Release-17 mapping rules for a PSSCH are maintained.

In an embodiment, a UE is provided, which includes a transceiver; and a processor configured to determine whether the UE is operating in a localized mode or an interlaced mode for SL communication, and in response to determining that the UE is operating in the interlaced mode, decode first stage SCI of a PSCCH based on an interlaced mapping scheme, decode second stage SCI of a PSSCH based on the decoded first stage SCI, and decode the PSSCH based on the decoded first and second stage SCI.

In an embodiment, a method performed by a UE includes determining whether the UE is operating in a localized mode or an interlaced mode for SL communication, and in response to determining that the UE is operating in the interlaced mode, decoding first stage SL control information (SCI) of a physical SL control channel (PSCCH) based on an interlaced mapping scheme, decoding second stage SCI of a physical SL shared channel (PSSCH) based on the decoded first stage SCE and decoding the PSSCH based on the decoded first and second stage SCI.

### BRIEF DESCRIPTION OF THE DRAWINGS

In the following section, the aspects of the subject matter disclosed herein will be described with reference to exemplary embodiments illustrated in the figures, in which:

FIG. 1 illustrates an example of control and data paths an NCIS;

FIG. 2 illustrates an example of an interlace 0 resource, when SCS=15 kHz;

FIG. 3 illustrates an example of multiplexing between a PSCCH and a PSSCH is in time and frequency within a slot;

FIG. 4 illustrates an example of frequency interlacing to a PSSCH that may take place over a shared radio frequency band or an unlicensed band, according to an embodiment;

FIG. 5 is a flowchart illustrating a UE operation for determining a subchannel/interlace size, according to an embodiment;

FIG. 6 illustrates PSSCH!PSCCH multiplexing option 1, according to an embodiment;

FIG. 7 illustrates PSSCHIPSCCH multiplexing option 2, according to an embodiment;

FIG. 8 illustrates PSSCHIPSCCH multiplexing option 3, according to an embodiment;

FIG. 9 illustrates PSSCH/PSCCH multiplexing option 4, according to an embodiment;

FIG. 10 is a flowchart illustrating a procedure for a LIE to receive a PSSCH, according to an embodiment;

FIG. 11 illustrates SL communication using a frequency-interlaced waveform that may assign one or more additional frequency interlaces for PSSCH communication, according to an embodiment;

FIG. 12 illustrates another SL communication scheme using a frequency-interlaced waveform, according to an embodiment;

FIG. 13 illustrates an example of a PSFCH structure and associated mapping, according to an embodiment; and

FIG.15 is a block diagram of an electronic device in a network environment, according to an embodiment.

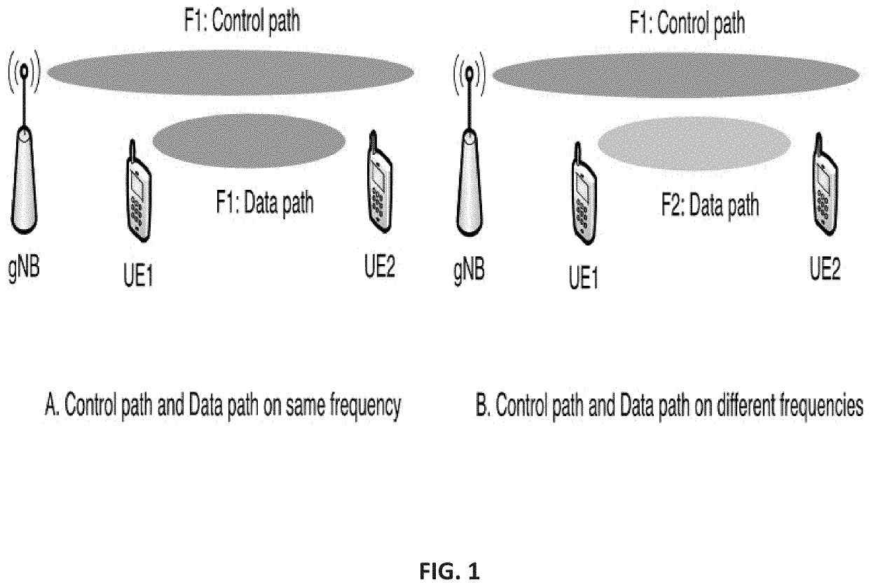

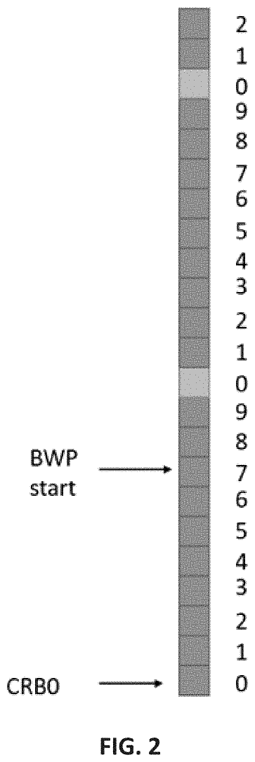

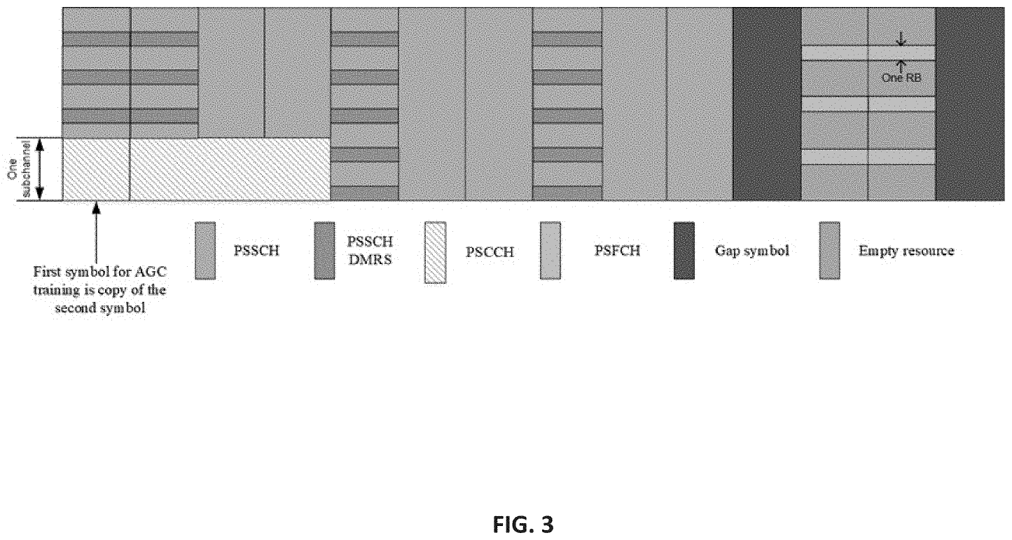

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment”or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises”and/or “comprising,” when used in this specification, specify the presence of stated features, integers, steps, operations, elements, and/or components, but do not preclude the presence or addition of one or more other features, integers, steps, operations, elements, components, and/or groups thereof.

It will he understood that when an element or layer is referred to as being on, “connected to” or “coupled to” another element or layer, it can be directly on; connected or coupled to the other element or layer or intervening elements or layers may be present. In contrast, when an element is referred to as being “directly on,” “directly connected to” or “directly coupled to” another element or layer, there are no intervening elements or layers present. numerals refer to like elements throughout. As used herein, the term “and/or” includes any and all combinations of one or more of the associated listed items.

The terms “first,” “second,” etc., as used herein, are used as labels for nouns that they, precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module”refers to any combination of software, firmware and/or hardware configured to provide the functionality described herein in connection with a module. For example, software may be embodied as a software package, code and/or instruction set or instructions, and the term “hardware,”as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC); system on-a-chip (SoC), an assembly, and so forth.

In order to meet the above-described PSD and OCB regulation requirements, the present disclosure builds on the NR-U framework by defining an interlaced structure when mapping the SL channel to the resource blocks.

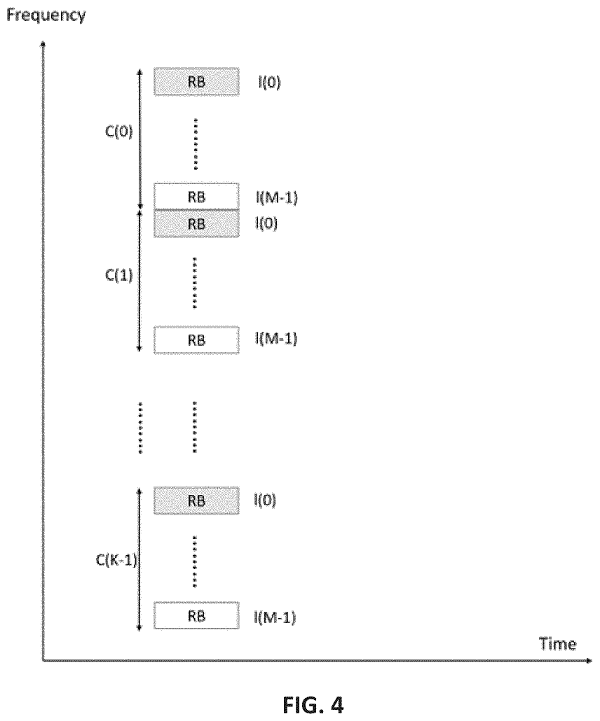

FIG. 4 illustrates an example of frequency interlacing to a PSSCH that may take place over a shared radio frequency band or an unlicensed band, according to an embodiment. Referring to FIG. 4, the available RBs are divided into K clusters (C(0) to C(K−1)). Each of these clusters includes M RBs.

To perform the interlacing, the PSSCH should be spread out in frequency. To achieve this, M interlaces (i.e., I(0), I(1), . . . , I(M−1)) are defined, where each interlace occupies one RB from each cluster. For example, a first interlace (i.e., I(0)) will occupy the first RB (i.e., RB0) in each of the K clusters. As such, a first interlace will occupy RBs (0, M, 2M, . . . , (K−1)*M) and interlace i would occupy RBs, i, (i+M, . . . , i+(K−1)*M). Generally speaking, an interlace may be defined by an offset value (between 0 and M−1) that indicates the first RB used in the frequency.

Alternatively, the interlace could be defined on another resource granularity, rather than a single RB, (e.g., a group of RBs or a fraction of a RBs (e.g., ½ RB)).

Conceptually, to map the frequency interlacing to the current SL design, one interlace can be defined as being equivalent to a subchannel, but instead of having contiguous resources, the resources are distributed in frequency. Thus, an interlace can be viewed as a “virtual subchannel”.

Alternatively, more than 1 frequency interlaces can be (pre-)defined as a “virtual subchannel”, depending on the size of a “virtual subchannel”. The mapping between an interlace and sub-channels can be pre-configured or RRC configured for each resource pool.

An interlace may be (pre-)configured by RRC signaling. In accordance with an embodiment of the disclosure, no new signaling is needed. The RRC configuration structure for the resource pool SL_ResourcePool) can be reused ‘as is’. However, the actual mapping to PRBs is changed in the sense that it will assume contiguous PRBs when operating in a licensed spectrum and interlaced PRBs when operating in an unlicensed spectrum.

In addition, the interlace (e.g., the number of clusters and the cluster size) may be automatically obtained by the UE once a bandwidth and a subchannel size is known. For example, when a bandwidth is 100 PRBs and a subchannel size is 10 PRBs (i.e., 10 subchannels occupy the bandwidth), the UE can automatically infer, when operating in the unlicensed band, that it will have an interlaced structure, whereby 100/10 clusters are defined, each having 10 PRBs. Subsequently, the same approach may be followed to identify the 10 interlaces and accordingly follows the interlacing mapping role when mapping the transmission of its subchannels over the actual RBs. In other words, when the UE operates in a licensed spectrum, the UE interprets sl-SubehanneiSize (i.e., the parameter giving the subchannel size in PRBs) as indicating the size of a subchannel in contiguous RBs, whereas when the UE operates in unlicensed spectrum, the UE interprets this parameter as the PRBs belonging to an interlace with a given comb factor.

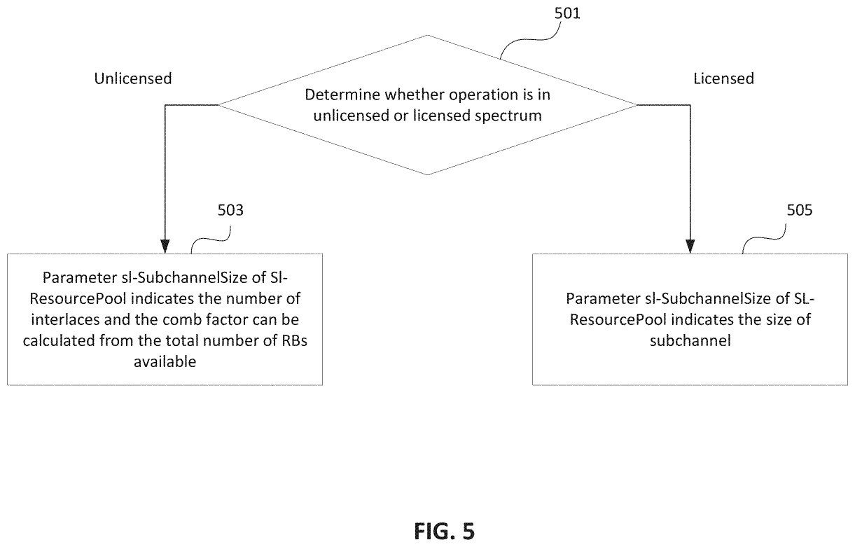

FIG. 5 is a flowchart illustrating a UE, operation for determining a subchannel/interlace size, according to an embodiment. More specifically, FIG. 5 illustrates a method of selecting either interlaced or contiguous operation based on the use of licensed/unlicensed spectrum.

Referring to FIG. 5, in step 501, the UE determines whether is operating in a licensed spectrum or an unlicensed spectrum.

In response to determining operation in the unlicensed spectrum in step 501, the UE utilizes the parameter sl-SubchanneiSize of Sl-ResourcePool as an indicator of the number of interlaces and calculates a comb factor from the total number of available RBs in step 503.

However, in response to determining operation in the licensed spectrum in step 501, the UE utilizes the parameter sl-SubchanneLSize of SL-ResourcePool an indicator of the size of subchannel in step 505.

Although FIG. 5 has been described above with the use of licensed/unlicensed spectrum to make the determination, this is only one example. Alternatively, the disclosure may rely on other parameters, or could be based on an entirely new RRC parameter.

In addition, deciding whether a UE is operating in licensed or unlicensed spectrum can be pre-configured. For example, the unlicensed bands can be pre-configured in the UE and according to its carrier frequency, the UE can identify whether it is operating in a licensed or an unlicensed band.

In some cases, a PSSCH can occupy one or more interlaces. The interlace allocation may be done in a similar fashion as subchannel allocation, but with the interlace being an atomic block for the resource allocation, That is, an interlacing structure is configured separately (i.e., the number of interlaces and the number of RBs in each interlace) from the subchannel size. Subsequently, the subchannel size may be mapped to one or more interlaces depending on its size. For example, if a subchannel size is 20 PRBs and the interlace has 10 PRBs, then each subchannel will be mapped to 2 interlaces.

Each frequency interlace may include K PRBs, evenly spaced over the frequency band, where K is a positive integer and i may vary between 0 and M−1. Thus, the PRBs in a particular frequency interlace are spaced apart from each other by at least one other PRB. For example, as described above with reference to FIG. 4, a frequency interlace may include RBs from cluster C(0) to C(K−1), where each interlace occupies one RB from each cluster. However, the values of K and M may vary based on several factors, such as the bandwidth, the SCS, and/or the PSD limitation of the frequency band. Additionally, the number of clusters or the value of K may be dependent on the amount of frequency distribution required to maintain a certain bandwidth occupancy.

Herein, two PSSCH transmission modes are described; localized PSSCH transmission and interlaced PSSCH transmission,

In localized PSSCH transmission, a continuous RB structure is used, and the transmission is based on Release-17 mapping. In interlaced PSSCH transmission, interlaces are used for the PSSCH transmission, as will be described below.

PSCCH Structure and Multiplexing with PSSCH

In Release-16, as described above, the PSCCH is located on a subset of the PRBs used for the PSSCH (i.e., depending on configuration) and is located in the first subchannel in case the -LIE transmission occupies multiple subchannels. However, such a structure cannot be exactly reused for an interlaced PSSCH, and thus a new PSCCH structure, as well as new rules for linking a PSCCH to its associated PSSCH are needed. Different options of multiplexing patterns between a PSCCH and a PSSCH can be RRC-configured by a gNB, or can be pre-configured for each SL resource-pool.

Option 1: a PSCCH is located in the lowest PRBs of one or more interlaces. The PSCCH occupies a subset of the PRBs as its associated PSSCH. This depends on the number of frequency interlaces per PSCCH subchannel and the number of interlaces per PSSCH subchannel, as well as the number of interlaces used by the LTE for the transmission. The PSCCH may occupy some or all of the symbols where it can be transmitted (potentially excluding some, such as guard symbols, AGC symbols, PSFCH symbols, etc.).

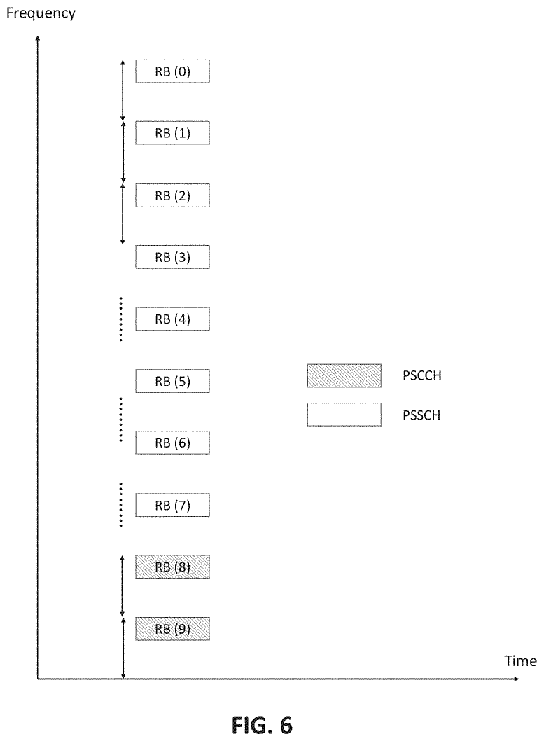

FIG. 6 illustrates PSSCH/PSCCH multiplexing option 1, according to an embodiment.

Referring to FIG. 6, it can be seen that this option is similar to the current SL design, except that the PRBs are interlaced and not continuous.

Option 2: both highest and lowest PRB(s) of one or more interlaces are used for transmitting a PSCCH. Option 2 is provided to ensure frequency diversity gain, since the PRBs will be highly separated in frequency. In option 2, a new parameter may be provided that indicates how the PSCCH PRBs are split between the highest and lowest PRBs, which can be configured per resource pool. For example, configuring a PSCCH size in terms of PRBs and configuring the new parameter to 5 will indicate that the 5 lowest and 5 highest PRBs of an interlace are used. The remaining PRBs of the interlace can be used for the PSSCH transmission.

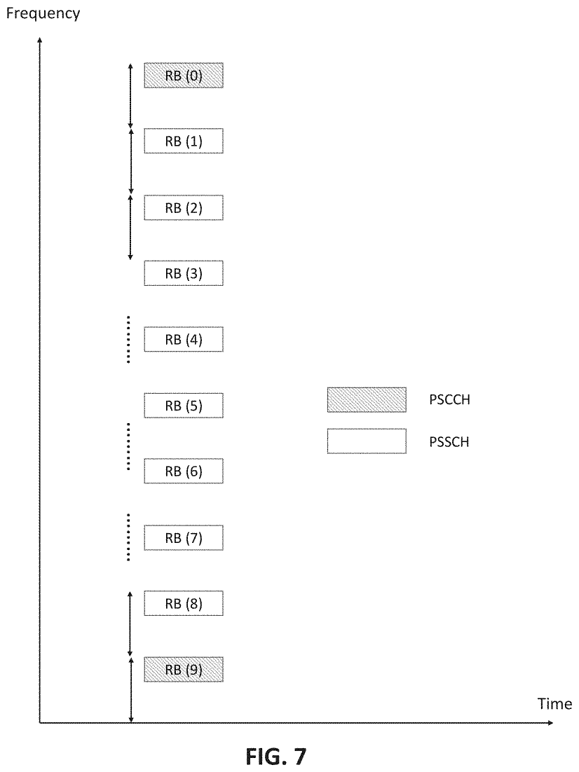

FIG. 7 illustrates PSSCH/PSCCH multiplexing option 2, according to an embodiment. Referring to FIG. 7, the PSCCH has a size of 2 PRBs and the lowest and highest PRBs are used for the PSCCH.

Option 3: a PSCCH is located in all (or a fraction) of the frequency interlaces, although only a fraction of the available symbols are used. The unused symbols can be left empty or may be used for PSSCH transmission. Alternatively, the unused symbols can be used to transmit standalone PSCCH (e.g., for other UEs).

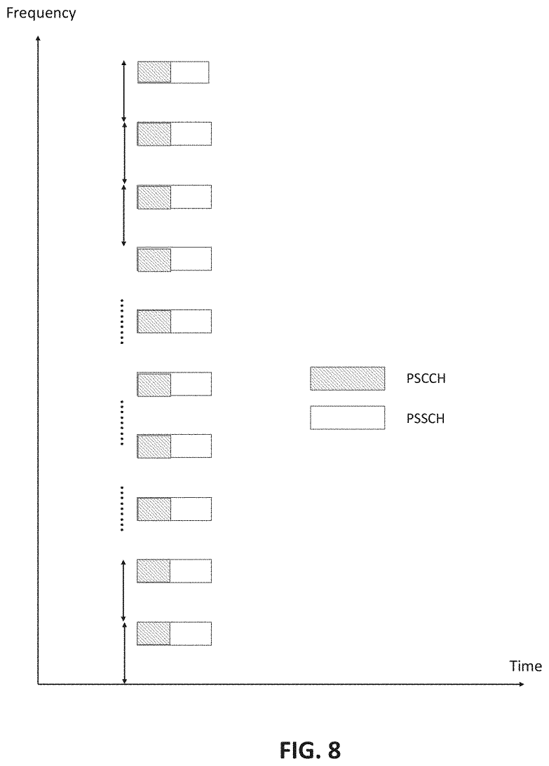

FIG. 8 illustrates PSSCH/PSCCH multiplexing option 3, according to an embodiment.

Referring to FIG. 8, a BS may configure a first time period for a PSCCH and a second time period for a PSSCH. The first time period may be adjacent to the second time period in order to reduce LBT delay. For example, a single LBT may be performed before the first and second time periods for the transmission of the PSCCH and the PSSCH.

In some instances, the second time period for the PSSCH may include a greater number of symbols than the first time period for the PSCCH.

In some instances, the first time period may include about 1-2 OFDM symbols for the PSCCH and the second time period may include 10-11 symbols for the PSSCH.

In some instances, a length of the first time period for the PSCCH may be predetermined.

A first UE may transmit SCI in the PSCCH during the first time period to the second UE, and a second UE may perform blind decoding in the time period to receive the SCI. While the PSSCH and the PSCCH are communicated during different time periods, for each PSSCH communication, the PSCCH may include an interlaced waveform.

Option 3 is similar to that of the current SL structure, when a UE uses only one subchannel for transmission and the size of the PSCCH subchannel is set to be equal to that of the PSSCH subchannel. In this case, the PSCCH occupies either the 2nd or 3rd OFDM symbols or the 2nd, 3rd, and 4th OFDM symbols in each slot.

Option 4: a PSCCH is located on all RBs where the PSSCH is transmitted and on all available symbols. The multiplexing is done within the PRBs. For example, a subcarrier with a lowest index is reserved for the PSCCH.

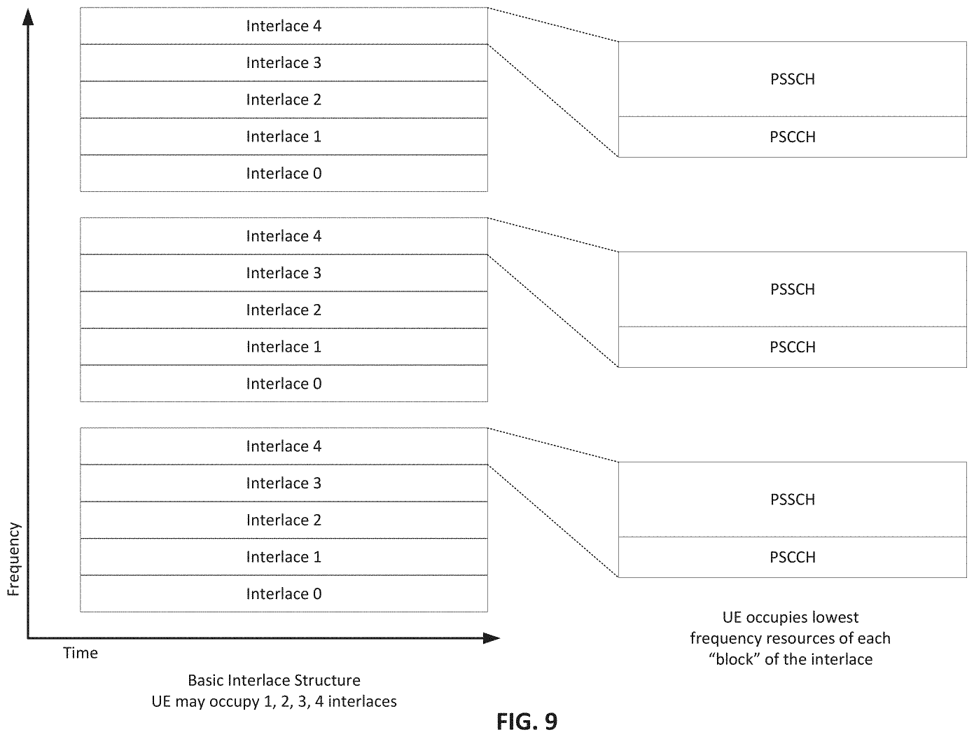

FIG. 9 illustrates PSSCH/PSCCH multiplexing option 4, according to an embodiment.

The different options of multiplexing patterns between a PSCCH and a PSSCH as described above can be RRC-configured by a DNB for each resource pool or for each SL UE, or can be pre-configured for each SL resource-pool.

Second Stage SCI Mapping and Structure with PSSCH

As described above, in SL, control SCI is sent in two stages. The first stage SCI is sent in a PSCCH and the second stage SCI is sent in a PSSCH along with data. The second stage SCI may be mapped to resource elements in first OFDM symbols that occur after a first DMRS symbol. In this case, the second stage SCI can be either time or frequency multiplexed with a payload in the PSSCH depending on its size. For example, the second stage SCI fills the subcarriers in an ascending order in the first OFDM symbol after that of the DIVERS, and once the subcarriers in the first OFDM symbol are all filled, subcarriers in a following OFDM symbol are used. This mapping strategy can also be considered here, except that PRBs over which the second stage SCI is sent are interlaced and not contiguous in the frequency domain.

PSSCH Resource Allocation Indication

As described above, two PSSCH mappings are possible; Release-16/17 mapping with localized subchannels or interlaced mapping.

These two mappings can be signaled in the same way. That is, for the same number of interlaces as there are subchannels, the interlaces can be allocated in the same way as the subchannels. For example, by viewing the frequency resource allocation field of the SCI as indicating the interlaces indices, existing SCI formats for the first stage (or at least for the frequency resource allocation can be maintained), and the frequency resource allocation field can be interpreted in the same way as for allocating subchannels, but for the interlaces. Similarly, the indication for the second stage SCI can be similar as for the localized case. Consequently, the existing SCI format 1 can also be used as is for signaling the interlaced PSSCH.

Blind decoding of the PSCCH can be done in the same way for interlaced and localized modes. For the localized mode, the UE attempts to decode the PSCCH on specific locations linked to the subchannel. For the interlaced mode, the same process may applied such that the UE attempts to decode the PSCCH on specific locations linked to the interlace.

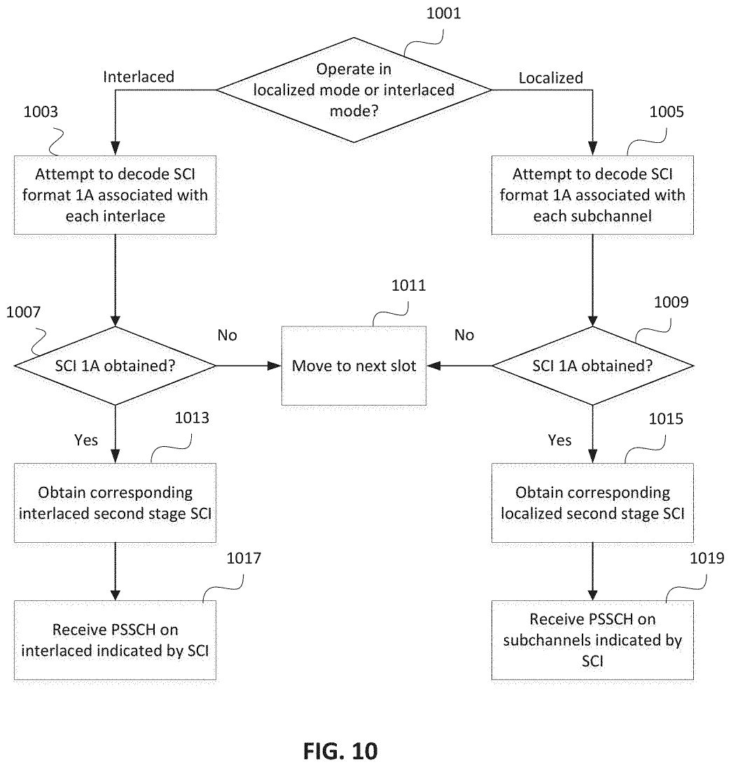

FIG. 10 is a flowchart illustrating a procedure for a UE to receive a PSSCH, according to an embodiment.

Referring to FIG. 10, in step 1001, the LT determines whether the system operates with a localized or interlaced PSSCH, i.e., in a localized mode or an interlaced mode. This can be done in several ways. For example, the determination can be based on the system deployment. That is, if the system is in unlicensed spectrum, the system operates with the interlaced mode. However, if the system is in the licensed spectrum, or spectrum dedicated for vehicle to everything (V2X) communication (e.g., the ITS band), the system operates in the localized mode.

There also can be some (pre-)configuration as to whether to use a localized or interlaced PSCCH, e.g., by RRC signaling. A field sl-Distributed may be added in the SL-ResourcePool IE in order to indicate if the UE operates with an interlaced or localized PSCCH. This allows some resource pools to use interlace mapping, while others use localized mapping.

Once the determination has been made, the UE attempts to blindly decode the PSCCH in step 1003 or 1005.

If it is determined that the localized mode is used, in step 1005, the UE looks at the PSCCH using the legacy mapping, with the Release-17 PSCCH to PSSCH mapping rile. However, if it is determined that the UE is in interlaced mode, in step 1003, the UE uses one of mapping options 1 to 4 as described above. For both steps 1003 and 1005, the blind detection complexity is the same. When performing the blind decoding in step 1003 or 1005, the UE attempts to decode the first stage SCI. The same SCI format, e.g., SCI format 1A, may be used for localized and interlaced mapping. The main difference, however, is how the frequency resource allocation field therein is interpreted. If the mode is localized, the frequency resource allocation field indicates subchannels, but if the mode is interlaced, the frequency resource allocation field indicates interlaces.

If the first stage SCI is not successfully obtaining in step 1007 or 1009, the UE moves a next slot in step 1011.

After successfully obtaining the first stage SCI in step 1007 or 1009, the UE decodes the second stage SCI in step 1013 or 1015. The format for the second stage SC1 is the same as Release-16/Release-17. However, where to locate the second stage SCI resources is different based on the type of mapping (i.e., either contiguous in one subchannel or interlaced in one subchannel), as described above.

After Obtaining both the first stage and second stage SCI, the LIE attempts to decode the PSSCH in step 1017 or 1019. The PSSCH location is known to the UE based on the resource allocation field. Additional information to decode the PSSCH (e.g., a HARQ process ID, a destination ID, etc.) is known based on the second stage SCI.

Based on the foregoing, a UE can perform sensing in the same way for localized and interlaced modes. As such, after the localized/interlaced determination, the LIE decodes the first stage SCI, and then knows which resources are occupied, either in terms of interlaces or subchannels.

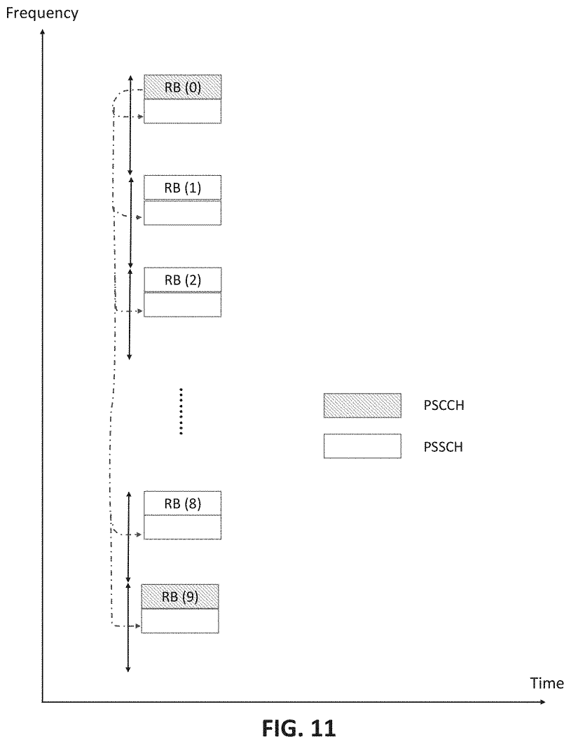

FIG. 11 illustrates SL communication using a frequency-interlaced waveform that may assign one or more additional frequency interlaces for PSSCH communication, according to an embodiment. Specifically, FIG. 11 illustrates a UE being allocated more than one interlace for its PSSCH.

For purposes of simplicity, FIG. 11 illustrates an assignment of only one additional frequency interlace for PSSCH communication, although this scheme may be applied to assign any suitable number of additional frequency interlaces for the PSSCH communications (e.g., 2, 3, 4, or more).

Referring to FIG. 11, similar to the FIG. 7, a BS may configure the highest-frequency RB(0) and the lowest-frequency RB(9) of the frequency interlace for the PSCCH and may configure the remaining RBs in the frequency interlace for the PSSCH. A first UE may assign an additional frequency interlace for the PSSCH, e.g., based on transmission data size.

While the example of FIG. 11 illustrates the additional frequency interlace to be adjacent or contiguous to the frequency interlace, the first UE may assign any other frequency interlace in the frequency band for the PSSCH communications. For example, when the frequency band includes M number of interlaces from l(0) to l(M−1), the first UE may assign a frequency interlace m as additional frequency domain resources for the PSSCH communications, where m may be between 1 to M−1. In some cases, the first UE may include in the transmission of the PSCCH, SCI to indicate to the second UE that the PSSCH communication is further transmitted in the additional frequency interlace l(1), as represented by the dotted arrows in FIG. 11. The first UE may transmit the SCI in the highest frequency RB(0) and may repeat the transmission of the SCI to the lowest frequency RB(9) of the frequency interlace l(0). Thus, a second UE may decode the SCI from the PSCCH communications and receive the PSSCH communications from the frequency interlace l(1) in addition to the RB(1) to RB(8) of the frequency interlace l(0). The SCI may indicate resource allocation information for additional frequency interlaces assigned for the PSSCH communications using a bitmap or an RIV (e.g., the RIV in legacy NR SL SCI).

In some embodiments, SL communications can be performed over a wideband, e.g., a BW of about 100 MHz. The wideband may be partitioned into multiple sub-bands, e.g., with a 20 MHz BW. To facilitate SL communications, the PSCCH communication may be communicated in a frequency interlace within a certain sub-band in the frequency band and a first UE may assign an additional frequency interlace in a different sub-band. The first UE may further indicate in the SCI which sub-band of the multiple sub-bands the additional frequency interlace is located in.

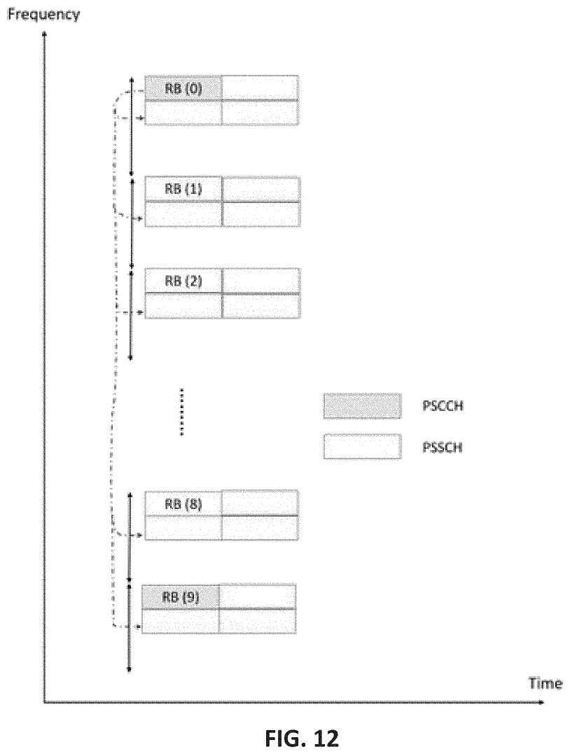

FIG. 12 illustrates another SL communication scheme using a frequency-interlaced waveform, according to an embodiment.

In FIG. 12, a PSSCH and a PSCCH are frequency-multiplexed onto the same frequency interlace l(0) and an additional frequency interlace l(1) is assigned for the PSCCH. This scheme may further assign additional time resources (e.g., an aggregation of timeslots) for the PSSCH communication.

For purposes of simplicity, FIG. 12 illustrates an assignment of only one additional time slot for the PSSCH communication, although the scheme may be applied to assign any suitable number of time slots for the PSSCH communication (e.g., about 2, 3, 4, or more).

Unlike the current SL design in which the PSCCH exists in each subchannel, the scheme in FIG. 12 offers better utilization of resources since more resource elements can be used for data transmission. However, this may come at the expense of lower sensing reliability, as the PSCCH is sent less than in a Release-16 system.

PSFCH Resource Allocation

Similar to the other channels, the PSFCH should also be distributed in frequency in order to substantially occupy the entire broadband. In Release-16, the PSFCH is localized in frequency. Thus, a new PSFCH resource mapping is needed. Herein, two schemes are provided: a first one that relies on interlacing at the RB level, and a second one that relies on interlacing at the subcarrier level.

RB Interlacing Scheme

Here, interlaces are defined in frequency. For a PSFCH transmission, all PRBs of a defined frequency interlace (e.g., same as the frequency interlace defined for PSSCH) can be used to transmit a NACK or an ACK in repetitions that spread over the entire RB set. For example, each interlace for a PSFCH transmission consist of 4 RBs, and each of the 4 RBs are used for transmitting the same ACK or NACK, similar to PUCCH Release-16 NR-U.

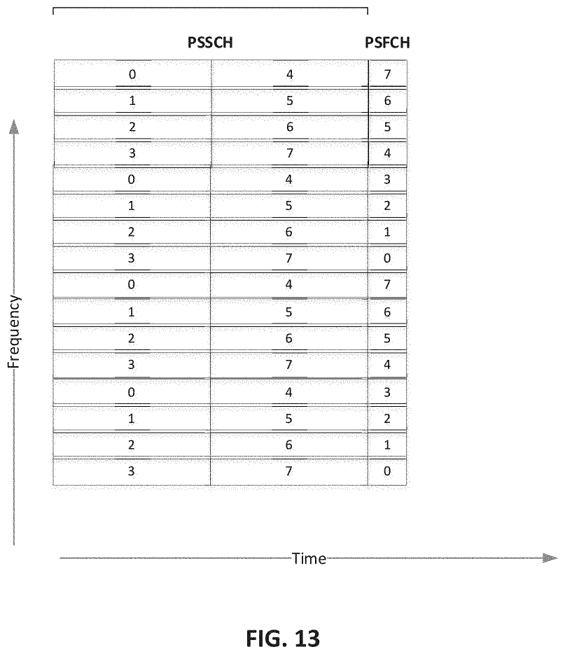

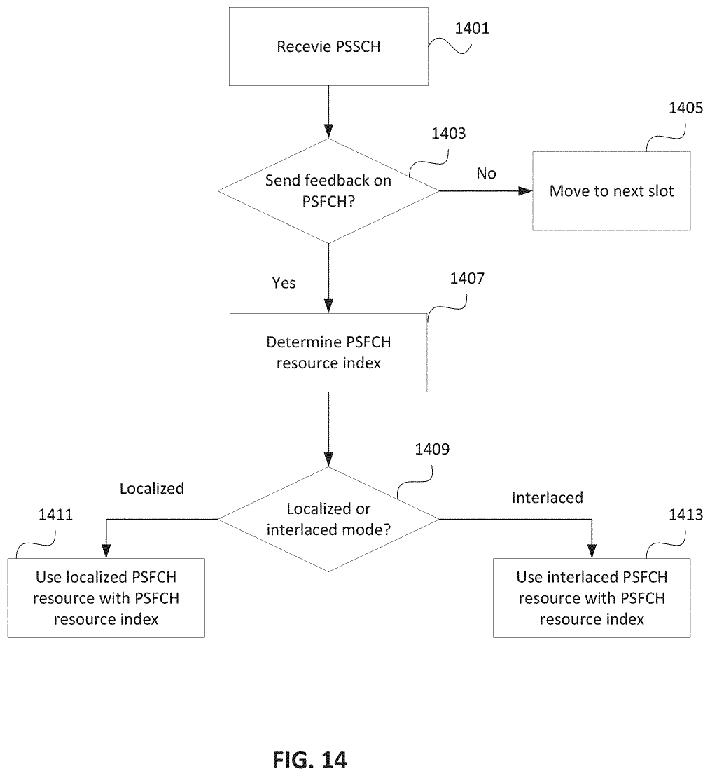

FIG. 13 illustrates an example of a PSFCH structure and associated mapping, according to an embodiment.

Referring to FIG. 13, there are 16 PRBs and 4 interlaces, and the PSFCH is transmitted every other slot. Accordingly, 8 interlaced PSSCHs can be transmitted before a PSFCH occasion occurs. Consequently, 8 PSFCH resources in time and frequency are defined. It is noted, however, that more PSFCH resources are available, as code division multiplexing (CDM) may be applied on top of each RB.

As illustrated in FIG. 13, each interlace occupies 2 PRBs, and the PSFCH is repeated over the two RBs of one PSFCH.

Repeating the same PSFCH signal across all resource blocks, however, may result in an increase cubic metric, requiring a larger back-off in a power amplifier. To mitigate this, a phase rotation (corresponding to a cyclic shift in time domain) may be cycled through a number of different possibilities across the number of different values across the RBs in the defined interlace. This phase rotation can be configured for each resource pool and can be applied by all UEs, similar to the concept of frequency hopping in a Uu link. Hence, this method should not impact the mapping rules for the PSFCH.

To support a frequency interlaced PSFCH design, the existing specification of PSFCH resource mapping may be changed from RB based mapping to frequency interlace based mapping. More specifically, a UE is provided by sl-PSFCH-Interlace-Set-r18 with a set of M_{Inter, set}^{PSFCH} (pre-defined) frequency interlaces in a resource pool for a PSFCH transmission in an interlaced resource pool. For a number of N_{subch} sub-channels for the resource pool. provided by sl-NumSubchannel, and a number of PSSCH slots associated with a PSFCH slot that is less than or equal to N_{PSSCH}^{PSFCH}, the UE allocates the [(i+j·N_{PSSCH}^{PSFCH})·M_{subch, slot}^{PSFCH}, (i+1+j·N_{PSSCH}^{PSFCH})·M_{subch, slot}^{PSFCH}−1] interlaces from the M_{Inter, set}^{PSFCH} interlaces to a slot i among the PSSCH slots associated with a PSFCH slot and a sub-channel j, where M_{subch, slot}^{PSFCH}=M_{Inter, set}^{PSFCH}(N_{subch}·N_{PSSCH}^{PSFCH}), 0≤i<N_{PSSCH}^{PSFCH}, 0≤j<N_{subch}, and the allocation starts in an ascending order of i and continues in an ascending order of j. The UE expects that M_{Inter, set}^{PSFCH} is a multiple of N_{subch}·N_{PSSCH}^{PSFCH}.

A UE determines a number of PSFCH interlaces available for multiplexing HARQ-ACK information in a PSFCH transmission as R_{inter, CS}^{PSFCH}=N_{type}^{PSFCH}·M_{subch, slot}^{PSFCH}·N_{CS}^{PSFCH}, where N_{CS}^{PSFCH} is a number of cyclic shift pairs for the resource pool and, based on an indication by higher layers:

N_{type}^{PSFCh}=1 and the M_{subch, slot}^{PSFCH} interlaces are associated with the starting sub-channel of the corresponding PSSCH; or

N_{type}^{PSFCH}=N_{subch}^{PSSCH} and the N_{subch}^{PSSCH}·M_{subch, slot}^{PSFCH} interlaces are associated with one or more sub-channels from the N_{subch}^{PSSCH} sub-channels of the corresponding PSSCH.

The PSFCH resources are first indexed according to an ascending order of the interlace index, from the N_{type}^{PSFCH}·M_{subch, slot}^{PSFCH} interlaces, and then according to an ascending order of the cyclic shift pair index from the N_{CS}^{PSFCH} cyclic shift pairs.

A UE determines an index of a PSFCH interlace for a PSFCH transmission in response to a PSSCH reception as (P_{UD}+M_{ID})modR_{unter, CS}^{PSFCH}, where P_{ID} is a physical layer source ID provided by SCI format 2-A or 2-B scheduling the PSSCH reception, and M_{ID} is the identity of the UE receiving the PSSCH, as indicated by higher layers, if the UE detects SCI format 2-A with a cast type indicator field value of “01”; otherwise, M_{ID} is zero.

While the PSFCH mapping is different in the above-described process, the same procedure as defined in Release-16 for PSSCH to PSFCH mapping can be reused.

Subcarrier Interlacing Scheme

An RB interleaving scheme, as described above, is generally suitable when the PSFCH is used for low payloads (e.g., ACK/NACK feedback). However, a possible drawback of this type of method is that the PSFCH capacity may be reduced, as compared with when the PSSCH is transmitted on localized subchannels, due to repeated transmissions of the ACK/NACK sequences in order to achieve the interlacing. To alleviate this possible drawback, a subcarrier-level interlacing may be performed, as described below.

Subcarrier-level interlacing may be performed by using a comb structure at the subcarrier level (or group of subcarriers). For instance, the design of the current PSFCH occupies 1 PRB, which is equivalent to 12 resources at the subcarrier level. To keep the same format and the same payload as in Rel-16, the following is performed:
Determine the number of PRBs N in a carrier.
Determine a comb factor as N. As a result, the number of PSFCH interlaces is the same as the number of PRBs in legacy systems. Thus, the number of PSFCH resources is the same with the interlacing case as for the localized subchannel case. As such, there is no loss in capacity on the PSFCH.

The interlacing at the subcarrier level can be done in several ways. One method is to use interleaved frequency division multiple access (IFDMA) modulation with a repetition factor k. Another method is to use OFDM, but to transmit only on a limited number of subcarriers by following a comb structure similar to that used by a channel state information reference signal (CSI-RS). This is sometimes referred to as interleaved OFDM.

Given that there is the same number of PSFCH resources for the interlaced PSFCH as for the legacy PSFCH, the mapping rule for the PSSCH to PSFCH can be the same for the interlaced and localized subchannel cases, which is a benefit of this scheme. In addition, the same group size of groupcast in case of groupcast option 2 can be supported. Finally, for the assistance sent in the Release-17 scheme over the PSFCH, there would be the same capacity to support the assistance information if the subcarrier interlacing approach is used.

As a further refinement, it may be desirable to not use adjacent interlaces whenever possible, in order to limit inter-carrier-interference (ICT). This can be done by indexing adjacent interlaces in a non-adjacent way. For example, if M PSSCH interlaces are defined, PSFCH interlacing l can start at subcarrier index l*N/M. Conceptually, this is the same as for localized subchannel, where N/M is equivalent to the channel size. For localized RBs, a PSFCH is on RBs 0, N/M, 2N/M, etc. For interlaced, essentially the same rule may be applied.

FIG. 14 is a flow chart illustrating a method of sending a PSFCH, according to an embodiment.

Referring to FIG. 14, in step 1401, the UE receives a PSSCH.

In step 1403, the UE determines if feedback is to be sent on a PSFCH. If there is no feedback, the IJE moves to a next slot in step 1405.

However, if there is feedback in step 1403, the UE determines a PSFCH resource index in step 1407. The determination is the same for localized and interlaced mode.

In step 1409, the UE determines whether the localized mode or the interlaced mode is used. When the UE uses the localized mode, the Release-17 procedure is used to send the PSFCH on the determined index in step 1411. However, when the UE uses the interlaced mode, an interlaced PSFCH mapping (e.g., either of the RB or subcarrier interlacing approaches described above) are used. A selection between the two interlacing approaches can be done based on an RRC configuration.

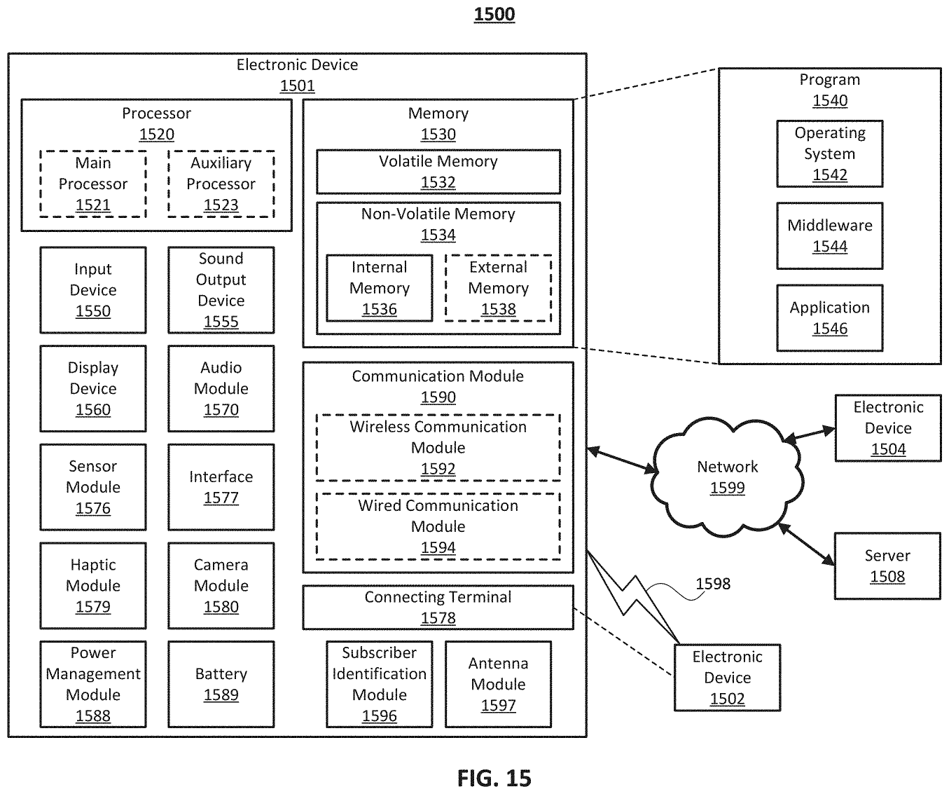

FIG. 15 is a block diagram of an electronic device in a network environment 1500, according to an embodiment. For example, an electronic device 1501 may be a LE for performing the above-described procedures and schemes.

Referring to FIG. 15, the electronic device 1501 in a network environment 1500 may communicate with an electronic device 1502 via a first network 1598 (e.g., a short-range wireless communication network), or an electronic device 1504 or a server 1508 via a second network 1599 (e.g., a long-range wireless communication network). The electronic device 1501 may communicate with the electronic device 1504 via the server 1508. The electronic device 1501 may include a processor 1520, a memory 1530, an input device 1540, a sound output device 1555, a display device 1560, an audio module 1570, a sensor module 1576, an interface 1577, a haptic module 1579, a camera module 1580, a power management module 1588, a battery 1589, a communication module 1590, a subscriber identification module (SIM) card 1596, or an antenna module 1594. In one embodiment, at least one (e.g., the display device 1560 or the camera module 1580) of the components may be omitted from the electronic device 1501, or one or more other components may be added to the electronic device 1501. Some of the components may be implemented as a single integrated circuit (IC). For example, the sensor module 1576 (e.g., a fingerprint sensor, an iris sensor, or an illuminance sensor) may be embedded in the display device 1560 (e.g., a display).

The processor 1520 may execute software (e.g., a program 1540) to control at least one other component (e.g., a hardware or a software component) of the electronic device 1501 coupled with the processor 1520 and may perform various data processing or computations.

As at least part of the data processing or computations, the processor 1520 may load a command or data received from another component (e.g., the sensor module 1546 or the communication module 1590) in volatile memory 1532, process the command or the data stored in the volatile memory 1532, and store resulting data in non-volatile memory 1534. The processor 1520 may include a main processor 1521 (e.g., a central processing unit (CPU) or an application processor (AP)), and an auxiliary processor 1523 (e.g., a graphics processing unit (GPU), an image signal processor (ISP), a sensor hub processor, or a communication processor (CP)) that is operable independently from, or in conjunction with, the main processor 1521. Additionally or alternatively, the auxiliary processor 1523 may be adapted to consume less power than the main processor 1521, or execute a particular function, The auxiliary processor 1523 may be implemented as being separate from, or a part of, the main processor 1521.

The auxiliary processor 1523 may control at least some of the functions or states related to at least one component (e.g, the display device 1560, the sensor module 1576, or the communication module 1590) among the components of the electronic device 1501, instead of the main processor 1521 while the main processor 1521 is in an inactive (e.g., sleep) state, or together with the main processor 1521 while the main processor 1521 is in an active state (e.g., executing an application). The auxiliary processor 1523 (e.g., an image signal processor or a communication processor) may be implemented as part of another component (e.g., the camera module 1580 or the communication module 1590) functionally related to the auxiliary processor 1523.

The memory 1530 may store various data used by at least one component (e.g., the processor 1520 or the sensor module 1576) of the electronic device 1501. The various data may include, for example, software (e.g., the program 1540) and input data or output data for a command related thereto. The memory 1530 may include the volatile memory 1532 or the non-volatile memory 1534.

The program 1540 may be stored in the memory 1530 as software, and may include, for example, an operating system (OS) 1542, middleware 1544, or an application 1546.

The input device 1550 may receive a command or data to be used by another component (e.g., the processor 1520) of the electronic device 1501, from the outside (e.g., a user) of the electronic device 1501. The input device 1550 may include, for example, a microphone, a mouse, or a keyboard.

The sound output device 1555 may output sound signals to the outside of the electronic device 1501. The sound output device 1555 may include, for example, a speaker or a receiver. The speaker may be used for general purposes, such as playing multimedia or recording, and the receiver may be used for receiving an incoming call. The receiver may be implemented as being separate from, or a part of, the speaker.

The display de-vice 1560 may visually provide information to the outside (e.g., a user) of the electronic device 1501. The display device 1560 may include, for example, a display, a hologram device, or a projector and control circuitry to control a corresponding one of the display, hologram device, and projector. The display device 1560 may include touch circuitry adapted to detect a touch, or sensor circuitry (e.g., a pressure sensor) adapted to measure the intensity of force incurred by the touch.

The audio module 1570 may convert a sound into an electrical signal and vice versa. The audio module 1570 may obtain the sound via the input device 1550 or output the sound via the sound output device 1555 or a headphone of an external electronic device 1502 directly (e.g.., wired) or wirelessly coupled with the electronic device 1501.

The sensor module 1576 may detect an operational state (e.g., power or temperature) of the electronic device 1501 or an environmental state (e.g., a state of a user) external to the electronic device 1501, and then generate an electrical signal or data value corresponding to the detected state. The sensor module 1576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1577 may support one or more specified protocols to be used for the electronic device 1501 to be coupled with the external electronic device 1502 directly (e.g., wired) or wirelessly. The interface 1577 may include, for example, a high-definition multimedia interface (HDMI), a universal serial bus (USB) interface, a secure digital (SD) card interface, or an audio interface.

A connecting terminal 1578 may include a connector via which the electronic device 1501 may be physically connected with the external electronic device 1502. The connecting terminal 1578 may include, for example, an HDMI connector, a USB connector, an SD card connector, or an audio connector (e.g., a headphone connector).

The haptic module 1579 may convert an electrical signal into a mechanical stimulus (e.g., a vibration or a movement) or an electrical stimulus which may be recognized by a user via tactile sensation or kinesthetic sensation. The haptic module 1579 may include, for example, a motor, a piezoelectric element, or an electrical stimulator.

The camera module 1580 may capture a still image or moving images. The camera module 1580 may include one or more lenses, image sensors, image signal processors, or flashes. The power management module 1588 may manage power supplied to the electronic device 1501. The power management module 1588 may be implemented as at least part of, for example, a power management integrated circuit (PMIC).

The battery 1589 may supply power to at least one component of the electronic device 1501. The battery 1589 may include, for example, a primary cell which is not rechargeable, a secondary cell which is rechargeable, or a fuel cell.

The communication module 1590 may support establishing a direct (e.g., wired) communication channel or a wireless communication channel between the electronic device 1501 and the external electronic device (e.g., the electronic device 1502, the electronic device 1504, or the server 1508) and performing communication via the established communication channel. The communication module 1590 may include one or more communication processors that are operable independently from the processor 1520 (e.g., the AP) and supports a direct (e.g., wired) communication or a wireless communication. The communication module 1590 may include a wireless communication module 1592 (e.g., a cellular communication module, a short-range wireless communication module, or a global navigation satellite system (;GLASS) communication module) or a wired communication module 1594 (e.g., a local area network (LAN) communication module or a power line communication (PLC) module). A corresponding one of these communication modules may communicate with the external electronic device via the first network 1598 (e.g., a short-range communication network, such as Bluetooth™, wireless-fidelity (Wi-Fi) direct, or a standard of the Infrared Data Association (IrDA)) or the second network 1599 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1592 may identify and authenticate the electronic device 1501 in a communication network, such as the first network 1598 or the second network 1599, using subscriber information (e.g., international mobile subscriber identity (IMSI)) stored in the subscriber identification module 1596.

The antenna module 1597 may transmit or receive a signal or power to or from the outside (e.g., the external electronic device) of the electronic device 1501. The antenna module 1597 may include one or more antennas, and, therefrom, at least one antenna appropriate for a communication scheme used in the communication network, such as the first network 1598 or the second network 1599, may be selected, for example, by the communication module 1590 (e.g., the wireless communication module 1592). The signal or the power may then be transmitted or received between the communication module 1590 and the external electronic device via the selected at least one antenna.

Commands or data may be transmitted or received between the electronic device 1501 and the external electronic device 1504 via the server 1508 coupled with the second network 1599. Each of the electronic devices 1502 and 1504 may be a device of a same type as, or a different type, from the electronic device 1501. All or some of operations to be executed at the electronic device 1501 may be executed at one or more of the external electronic devices 1502, 1504, or 1508. For example, if the electronic device 1501 should perform a function or a service automatically, or in response to a request from a user or another device, the electronic device 1501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1501. The electronic device 1501 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In sonic cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A user equipment (UE), comprising:
a transceiver; and
a processor configured to:
determine whether the UE is operating in a localized mode or an interlaced mode for sidelink (SL) communication, and
in response to determining that the UE is operating in the interlaced mode, decode first stage SL control information (SCI) of a physical SL control channel (PSCCH) based on an interlaced mapping scheme, decode second stage SCI of a physical SL shared channel (PSSCH) based on the decoded first stage SCI, and decode the PSSCH based on the decoded first and second stage SCI.

2. The LTE of claim 1, wherein resource blocks (RBs) of the PSSCH are divided into K clusters, each of the K clusters including M RBs, and
wherein M interlaces are defined, each of the M interlaces occupying one RB from each of the K clusters.

3. The LIE of claim 2, wherein the interlaced mapping scheme maps the PSCCH in a lowest RB of one or more of the M interlaces.

4. The UE of claim 2, wherein the interlaced mapping scheme maps the PSCCH in a lowest RB and a highest RB of one or more of the Ail interlaces.

5. The UE of claim 2, wherein the interlaced mapping scheme maps the PSCCH in each RB of the M interlaces, only occupying a portion of the symbols therein.

6. The UE of claim 2, wherein the interlaced mapping scheme maps the PSCCH on all RBs of one or more of the M interlaces on which the PSSCH is mapped, by multiplexing the PSCCH and the PSSCH within the RBs.

7. The-UE of claim 1, wherein the interlaced mapping scheme is radio resource control (RRC) configured by a base station.

8. The UE of claim 1, wherein whether the UE is operating in the localized mode or the interlaced mode is radio resource control (RRC) configured by a base station.

9. The UE of claim 1, wherein the first stage SCI is the same for the localized mode and the interlaced mode,
wherein the first stage SCI indicates interlace indices in the interlaced mode, and wherein the first stage SCI indicates subchannel indices in the localized mode.

10. The UE of claim 1, wherein the processor is further configured to:
receive at least one additional frequency interlace assignment for PSSCH communication from a transmitting UE, and
decode the PSSCH further based on the at least one additional frequency interlace assignment.

11. A method performed by a user equipment (UE), the method comprising:
determining whether the UE is operating in a localized mode or an interlaced mode for sidelink (SL) communication, and
in response to determining that t UE is operating in the interlaced mode, decoding first stage SL control information (SCI) of a physical SL control channel (PSCCH) based on an interlaced mapping scheme, decoding second stage SCI of a physical SL shared channel (PSSCH) based on the decoded first stage SCI, and decoding the PSSCH based on the decoded first and second stage SCI.

12. The method of claim 11, wherein resource blocks (RBs) of the PSSCH are divided into K clusters, each of the K clusters including M RBs, and
wherein M interlaces are defined, each of the M interlaces occupying one RB from each of the K clusters.

13. The method of claim 12, wherein the interlaced mapping scheme maps the PSCCH in a lowest RB of one or more of the M interlaces.

14. The method of claim 12, wherein the interlaced mapping scheme maps the PSCCH in a lowest RB and a highest RB of one or more of the M interlaces.

15. The method of claim 12, wherein the interlaced mapping scheme maps the PSCCH in each RB of the M interlaces, only occupying a portion of the symbols therein.

16. The method of claim 12, wherein the interlaced mapping scheme maps the PSCCH on all RBs of one or more of the M interlaces on which the PSSCH is mapped, by multiplexing the PSCCH and the PSSCH within the RBs,

17. The method of claim 11, further comprising receiving an indication of the interlaced mapping scheme via radio resource control (RRC) from a base station.

18. The method of claim 11, wherein whether the UE is operating in the localized mode or the interlaced mode is radio resource control (RRC) configured by a base station.

19. The method of claim 11, wherein first stage SCI is the same for the localized mode and the interlaced mode.
wherein the first stage SCI indicates interlace indices in the interlaced mode, and
wherein the first stage SCI indicates subchannel indices in the localized mode.

20. The method of claim 11, further comprising:
receiving at least one additional frequency interlace assignment for PSSCH communication from a transmitting UE; and
decoding the PSSCH further based on the at least one additional frequency interlace assignment.
